(19) United States
(12) Patent Application Publication
(10) Pub. No.: US 2007/0138403 A1
(43) Pub. Date: Jun. 21, 2007

(54) Particle optical apparatus

(76) Inventors: Dane Cubric, Manchester (GB); Pieter Kruit, Delft (NL)

Correspondence Address: STITES & HARBISON PLLC, 1199 NORTH FAIRFAX STREET, SUITE 900, ALEXANDRIA, VA, 22314, US

(21) Appl. No.: 10/569,963

(22) PCT Filed: Aug. 2, 2004
(86) PCT No.: PCT/GB04/03637

§ 371 Date: Jan. 29, 2007

(30) Foreign Application Priority Data
Aug. 28, 2003 (GB) 0320187.8

(51) Int. Cl. H01J 1/50

(52) U.S. Cl. 250/396 ML

(57) ABSTRACT

A particle optical apparatus including an aperture plate for shaping a particle beam before the particle beam enters a monochromator filter assembly. The aperture plate has at least one aperture and is adjustable with respect to the monochromator filter assembly, in normal operating conditions, so that the size of the aperture used to shape the particle beam can be varied, and therefore the beam current entering the filter assembly can be varied.

This invention relates to a particle optical apparatus. More specifically, the invention relates to an electron microscope.

A particle optical apparatus, such as an electron microscope is used in many different scientific fields for sample imaging and analysis. The particle optical apparatus produces a beam of charged particles which impinge on the sample to be studied. The energy spread of the particle beam, in combination with the chromatic aberration of the lenses contained within the apparatus leads to an increase in the spatial blur of the particle beam. This, in turn, decreases the spatial resolution of the optical apparatus.

In an electron microscope used for electron spectroscopy the energy spread of the particle beam leads to a decrease in the energy resolution of the measured spectra. This effect occurs in electron energy loss spectroscopy for example. Furthermore, the image contrast may be decreased due to the energy spread within the particle beam.

In view of these reasons, it is desirable to produce a particle beam in which the energy spread of the beam is minimised. The reduction in the energy spread of the particle beam is achieved in practice, by inserting an energy dispersive element (also called an energy monochromator or energy filter) into the path of the particle beam, and by using the energy dispersive element to select a portion of the beam with a particular energy spread.

Such an apparatus is described in U.S. Pat. No. 5,838,004 (Philips). This patent describes a high energy electron microscope which includes a monochromator filter assembly, characterized in that the apparatus is provided with a diaphragm which is situated at the entrance of the monochromator, and is rigidly connected to a part of monochromator in normal operating conditions. The diaphragm is not adjustable with respect to the filter assembly during normal operating conditions. This diaphragm significantly restricts the beam current that enters the monochromator filter.

This arrangement of the diaphragm rigidly connected to the monochromator filter of the electron microscope has one significant drawback. This diaphragm will permit only a fixed beam current to pass into the monochromator. In a Scanning Electron Microscope (SEM) system it may be desired to operate in a high resolution mode for imaging and to operate in a high current mode for analysis. When operating in the high current mode the operator may wish to vary the beam current that enters the monochromator filter assembly. In the apparatus of the Philips patent the diaphragm is optimised for the high resolution mode of operation, and in this case the maximum current of the particle beam will be limited, in many cases it will be below the beam current required to perform satisfactory analytical measurements. The maximum beam current of the particle beam is determined by several factors, these include the diameter of the aperture in the diaphragm, the brightness of the source of the particle beam and the gun lens voltage setting (the gun lens is a lens located after the particle source and before the diaphragm for focussing the particle beam). In an electron microscope the particle source is typically a field emission source or a Schottky emitter configured to provide optimum emission and brightness.

By changing the electrical settings of the gun lens it is possible to change the beam current entering the monochromator to a limited extent. This is achieved by setting the accelerating/decelerating mode of the lens.

Both the accelerating and decelerating modes image the electron source onto a selection slit of the monochromator filter, but will result in different magnifications. When the lens is configured in the decelerating mode the particle source is imaged onto the monochromator filter with a larger magnification than in the accelerating mode. The precise magnification is determined by the ratio of the image and source distance from the principal plane of the lens. The magnification is greater in the deceleration mode as the principal plane of the lens, created by an extraction electrode, the gun lens and the entrance to the monochromator filter, moves closer to the extraction electrode, thereby increasing the above mentioned ratio and leading to greater magnification. This large magnification value will provide a greater beam current to the monochromator, since the total beam current is proportional to the source brightness and the area of the source image at the selection slit.

However, this method of increasing the beam current has several negative consequences which it is preferable to avoid.

One of the first drawbacks of this current increase method is that change of the focussing mode also changes the aberration characteristics of the lens and this will influence the quality of the final image formed. The spherical and chromatic aberration coefficients will in practice, typically increase by a factor of 3.

Secondly, the effects of Coulomb interaction will become greater as the apparatus operates in the decelerating mode. This will increase the energy spread within the beam due to the increased electron-electron interactions within the beam (the Boersch effect), arising due to the lower electron energies.

Thirdly, the change of operating mode from accelerating to decelerating will also magnify any misalignment of the source with respect to the rest of the apparatus. This may therefore project the image at a position which is not optimised, and this has to be compensated for by the use of deflector electrodes. Using these further electrodes can introduce further aberration effects into the final image.

According to the invention there is provided a particle optical apparatus comprising a particle source for producing a primary beam of electrically charged particles; a monochromator filter assembly located after the particle source and an aperture plate containing at least one aperture for shaping the particle beam, located between the particle source and the monochromator filter assembly; characterized in that the aperture plate is adjustable with respect to the monochromator filter assembly during normal operation of the apparatus so that the size of the aperture for shaping the particle beam can be varied.

Typically, the particle optical apparatus includes a particle gun comprising the particle source and a gun lens located after the particle source for focussing the beam.

In this case, the invention avoids the three previously mentioned drawbacks. Firstly, the invention enables the beam current entering the monochromator filter to be varied, whilst the aberration coefficients of the lens are unchanged. Secondly, this invention enables operation in the accelerating mode at all times, to accelerate electrons within the region of the gun lens. This reduces the Boersch effect in the beam between the extraction electrode and the monochromator. Finally this invention prevents any misalignment of the particle beam which may occur as a result of adjusting lens magnification, since it does not require any adjustment of the magnification.

In a preferred embodiment of the invention the aperture plate contains two or more apertures of different sizes, and may be displaceable relative to the monochromator filter in order to selectively align a said aperture with the beam.

In an alternative embodiment the aperture plate is formed from two or more partial plates which cooperate to provide an aperture of variable size, wherein the aperture size is varied by moving the partial plates.

In preferred embodiments of the invention the aperture plate can be adjusted by mechanical or electronic means or means responsive to incident optical radiation

Embodiments of the invention are now described, by way of example only, with reference to the accompanying drawings in which:

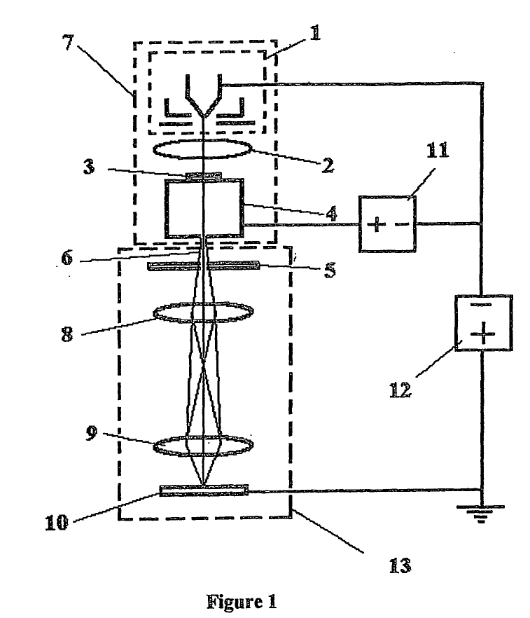

FIG. 1 shows a cross-sectional schematic view of an electron microscope including a monochromator filter assembly and an aperture plate;

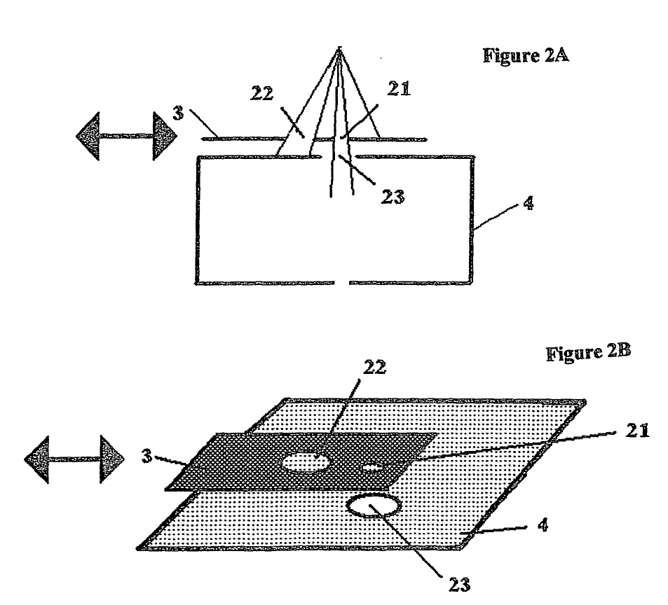

FIG. 2A shows a cross-sectional view of an aperture plate positioned at the entrance to the monochromator filter assembly;

FIG. 2B is a top view of the aperture plate positioned at the entrance to the monochromator filter assembly;

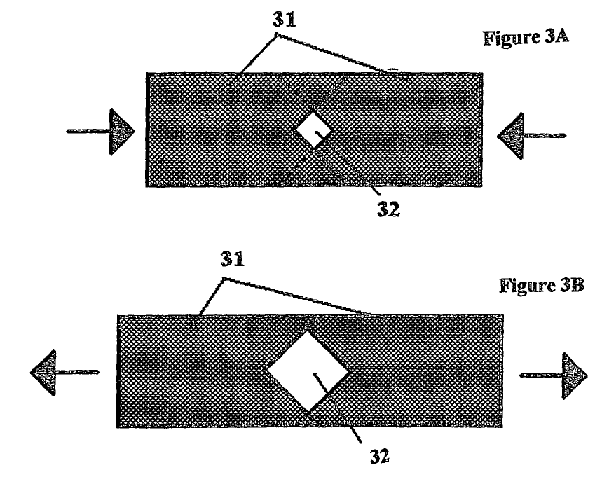

FIGS. 3A and 3B show an aperture plate comprising two partial plates according to a second embodiment of the invention;

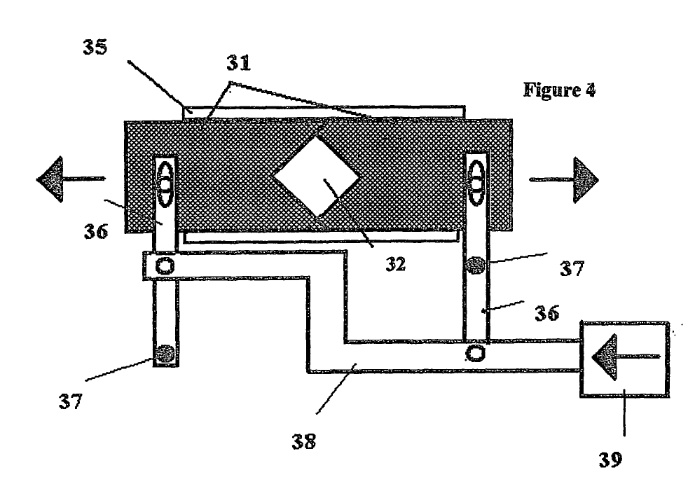

FIG. 4 shows a schematic view of the control mechanism for moving the aperture plate of FIG. 3.

FIG. 1 shows a simplified cross-section though an electron microscope. The microscope consists of a gun chamber (7) and a microscope column (13). The gun chamber (7) comprises particle source (1), gun lens (2), adjustable aperture plate (3) and monochromator filter assembly (4). The gun lens (2) is located after the particle source (1) and the aperture plate is located after the gun lens (2) at the entrance to the monochromator filter assembly (4). Alternatively, the adjustable aperture plate (3) can be located between the particle source (1) and the gun lens (2). The monochromator filter assembly (4) is preferably a Wien filter, though other types of filter can be used. A particle beam (6) exits the monochromator filter assembly (4) and is aligned with the optical axes of the microscope column (13). The microscope column (13) contains an anode (5) and electron optical elements comprised of a condenser lens (8) and an objective lens (9). These lenses project the particle beam (6) onto the sample (10), and in this apparatus the magnification of the lens can be adjusted. A voltage supply (12) lowers the potential of the particle source (1) with respect to the sample potential (the sample (10) is typically at ground) and determines the energy of the particle beam (6) at the sample (10).

The potential of the monochromator filter assembly (4) with respect to the particle source (1) is adjusted by voltage supply (11).

The particle source (1) is typically a Schottky source comprised of a filament, suppressor and extractor element.

FIGS. 2A and 2B show the aperture plate (3) with two apertures (21, 22) of different sizes, in this case 100 μm (21) and 200 μm (22) in diameter. The two apertures are spaced apart from each other on the aperture plate.

A third opening (23), that in practice could be the entrance aperture of the monochromator filter assembly (4) is located down steam of the aperture plate (3). The diameter of the third opening (23) is approximately the same diameter (200 μm) as the largest aperture (22) in the aperture plate (3). The aperture (21, 22) of the aperture plate (3) aligned with the opening (23) into the monochromator filter assembly (4) can be changed by moving the aperture plate (3) with respect to the monochromator filter assembly (4). The aperture plate (3) can be moved by the operator whilst the electron microscope is operating.

FIGS. 3A and 3B show an alternative embodiment of the aperture plate (3). This plate consists of two partial plates (31) each having a V-shaped section that cooperate to provide an aperture (32) of variable size. The two partial plates (31) overlap and can be independently moved in opposite directions. The movement of the partial plates (31) is such that the centre of the aperture (32) always remains at the same position relative to the monochromator filter (4) optical axes. This ensures that the aperture (32) remains precisely aligned with the optical axes of the monochromator filter (4).

There are several different mechanisms that can be used for moving the aperture plate (3) and these will depend on the particular construction of the gun chamber (7).

Firstly, the aperture plate (3) can be moved by a simple mechanical mechanism or manipulator connecting the plate (3) to the air side of the gun chamber (7). The mechanical mechanism preferably incorporates a section constructed from electrically insulating material, A1₂O₃ for example. This electrically insulating section enables the aperture plate (3) to be at a different voltage to other parts of the gun chamber (7).

Alternatively the aperture plate (3) can be moved by an electrical control mechanism, and is provided with electrical connectors similar to those provided for the electrodes within the monochromator filter assembly (4). This electrical connection may use a piezoelectric element within the gun chamber (7) to control movement of the aperture plate (3).

A further alternative is to use optically responsive control means to move the aperture plate (3). In this case the movement of the aperture plate (3) can be triggered by light falling through a window of the gun chamber. Such movement can be achieved, for example, using a bimetallic element which switches between two bistable positions in response to incident light, or by using electronic control means to move the aperture plate (3)

FIG. 4 shows one embodiment of a control mechanism for moving the partial plates (31) of FIGS. 3A and 3B with respect to the monochromator filter assembly (4). As described above, with reference to FIGS. 3A and 3B partial plates (31) cooperate to form an aperture plate (3) with an aperture (32) of variable size. A guide element (35), preferably made of metal is provided as a guide for the partial plates (31) to slide along. Drive element (39) is a piezo or mechanical drive element connected to a movement transfer bar (38). Moveable bars (36) are connected to movement transfer bar (38) and have pivot points (37). Drive element (39) acts on movement transfer bar (38) to cause bars (36) to pivot about the pivot points (37). This leads to movement of the plate sections (31), and hence the size of the aperture (33) is varied.

The mechanical elements that make up the aperture plate (3) and the movement control mechanisms can all be made using standard machining processes, or they can be machined as a microelectromechanical system.

1. A particle optical apparatus comprising a particle source for producing a primary beam of electrically charged particles; a monochromator filter assembly located after the particle source and an aperture plate containing at least one aperture for shaping the particle beam, located between the particle source and the monochromator filter assembly; characterized in that the aperture plate is adjustable with respect to the monochromator filter assembly during normal operation of the apparatus so that the size of the aperture for shaping the particle beam can be varied.

2. A particle optical apparatus according to claim 1 wherein the aperture plate contains two or more apertures of different sizes.

3. A particle optical apparatus according to claim 2 wherein the aperture plate has more then one said aperture and is displaceable relative to the monochromator filter to selectively align a said aperture with the beam.

4. A particle optical apparatus according to claim 1 wherein the aperture plate is formed from two or more partial plates.

5. A particle optical apparatus according to claim 4 wherein the partial plates co-operate to provide an aperture of variable size.

6. A particle optical apparatus according to claim 5 wherein the partial plates can move towards or away from the centre of the aperture to vary the size of the aperture.

7. A particle optical apparatus according to claim wherein the aperture plate is adjustable using mechanical control means.

8. A particle optical apparatus according to claim 7 wherein the mechanical control means incorporates a section made from electrically insulating material.

9. A particle optical apparatus according to claim 8 wherein the electrically insulating material is Aluminium Oxide (A1203).

10. A particle optical apparatus according to claim 1 wherein the aperture plate is adjustable using electronic control means.

11. A particle optical apparatus according to claim 10 wherein the electronic control means is a piezoelectric control means.

12. A particle optical apparatus according to claim 1 wherein the aperture plate is adjustable using means responsive to incident optical radiation.

13. A particle optical apparatus according to claim 12 wherein said means responsive to incident optical radiation is a bimetallic component.

14. A particle optical apparatus according to claim 12 wherein said means responsive to incident optical radiation is an electronic control means.

15. A particle optical apparatus according to claim 1 including</RTI> a particle gun comprising said particle source and a gun lens located after said particle source for focussing the beam, the aperture plate being located between the gun lens and the monochromator filter assembly.

16. A particle optical apparatus according to claim 1 including a particle gun comprising said particle source and a gun lens located after said particle source for focussing the beam, the aperture plate being located between the particle source and the gun lens.

17. A particle optical apparatus according to claim 1 wherein the monochromator filter assembly is a Wien filter.

18. (canceled)
